(19) United States
(12) Patent Application Publication
(10) Pub. No.: US 2013/0074075 A1
(43) Pub. Date: Mar. 21, 2013

(54) Summary-Based Task Monitoring

(71) Applicants: Victor Fernandes Cavalcante, Campinas (BR); Claudio Santos Pinhanez, Sao Paulo (BR); Cleidson Ronald Botelho De Souza, Sao Paulo (BR)

(72) Inventors: Victor Fernandes Cavalcante, Campinas (BR); Claudio Santos Pinhanez, Sao Paulo (BR); Cleidson Ronald Botelho De Souza, Sao Paulo (BR)

(73) Assignee: INTERNATIONAL BUSINESS MACHINES CORPORATION, Armonk, NY (US)

(21) Appl. No.: 13/235,640

(22) Filed: Sep. 19, 2011

(51) Int. Cl. G06F 9/46

(52) U.S. Cl. 718/100

(57) ABSTRACT

A method, an apparatus and an article of manufacture for task monitoring. The method includes receiving at least one task action indication from a first user module, generating a summary of the at least one task action indication, and outputting the summary of the at least one task action indication to a second user module for monitoring.

### FIELD OF THE INVENTION

Embodiments of the invention generally relate to information technology, and, more particularly, to task monitoring.

### BACKGROUND OF THE INVENTION

In many areas of human work, the need for close supervision of one individual or group by another individual can be mandatory, essential, or desirable. Having someone else, often with previous experience in the task, monitoring a person's steps through the process of performing a task can be an effective way to decrease mistakes and assure compliance to guidelines. However, it is often challenging to devote sufficient resources for supervision work due to the added cost or scheduling difficulties. A common existing practice is to have fewer supervisors than supervisees, and time-share the time of the supervisors among the supervisees. Similarly, there are situations where the supervisor is also doing his or her own work, and taking breaks to monitor the work of the supervised workers.

However, monitoring another individual's activities through sampling, as noted above, imposes cognitive burdens on the supervisor. There is context switching between the activities of the multiple people supervised and/or the task being performed by the supervisor or supervisees. The challenge is compounded by the globalized nature of modern work, where the supervisor might not be in the same physical location as the supervisees.

### SUMMARY OF THE INVENTION

In one aspect of the present invention, techniques for summary-based task monitoring are provided. An exemplary computer-implemented method for task monitoring can include steps of receiving at least one task action indication from a first user module, generating a summary of the at least one task action indication, and outputting the summary of the at least one task action indication to a second user module for monitoring.

Another aspect of the invention or elements thereof can be implemented in the form of an article of manufacture tangibly embodying computer readable instructions which, when implemented, cause a computer to carry out a plurality of method steps, as described herein. Furthermore, another aspect of the invention or elements thereof can be implemented in the form of an apparatus including a memory and at least one processor that is coupled to the memory and operative to perform noted method steps. Yet further, another aspect of the invention or elements thereof can be implemented in the form of means for carrying out the method steps described herein, or elements thereof; the means can include (i) hardware module(s), (ii) software module(s), or (iii) a combination of hardware and software modules; any of (i)-(iii) implement the specific techniques set forth herein, and the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating an example network of analysts connected through a computational system, according to an embodiment of the present invention;

FIG. 2 is a diagram illustrating an example screen shot of a supervisor tracking tasks done by others using activity summaries, according to an embodiment of the present invention;

FIG. 3 is a diagram illustrating an example supervision scenario, according to an embodiment of the present invention;

FIG. 4 is a diagram illustrating an example sequence of a supervising cycle based on task awareness and summarization;

FIG. 5 is a flow diagram illustrating techniques for task monitoring, according to an embodiment of the invention; and

FIG. 6 is a system diagram of an exemplary computer system on which at least one embodiment of the invention can be implemented.

### DETAILED DESCRIPTION OF EMBODIMENTS

As described herein, an aspect of the present invention includes summary-based task monitoring, awareness, and learning. One embodiment of the invention enables a supervisor to more effectively monitor remote supervisees' work by presenting to the supervisor a computer-created summary of the work being performed by a supervisee. By means of summarization, the cognitive load and attention required by the supervisor is significantly decreased, allowing the supervisor to more easily monitor multiple individuals and/or perform his or her own tasks more readily. In one or more embodiments of the invention, summaries can be text or graphical summaries. For example, a summary of a supervisee's (for example, an employee's) work can be represented using thumbnails or shortened versions of commands.

Also, by way of example, consider a situation that includes a case of apprenticeship. Such a case can include monitoring where a less experienced individual watches a more senior or experienced individual perform his/her activities, aiming to learn new skills and improve his/her understanding of the situation and context. However, having an apprentice devoting his/her full time and attention to a mentor's work can be unproductive during his/her boarding period. Accordingly, an aspect of the invention can be used to facilitate an apprentice to engage more effectively with a mentor by allowing the apprentice to perform tasks while monitoring a summary-based version of the mentor's activities. An embodiment of the invention can also be implemented in connection with peers monitoring each other's activities, or bi-directionally by mentor(s) and apprentice(s) to simultaneously supervise/monitor and learn.

In one aspect of the invention, as detailed herein, the summaries are automatically generated by a computer system by processing the log of the person's activities on a computer, video or audio feeds from cameras and microphones in the supervised person's environment, and/or similar devices. In addition, summaries can be represented either as text or graphics, or both.

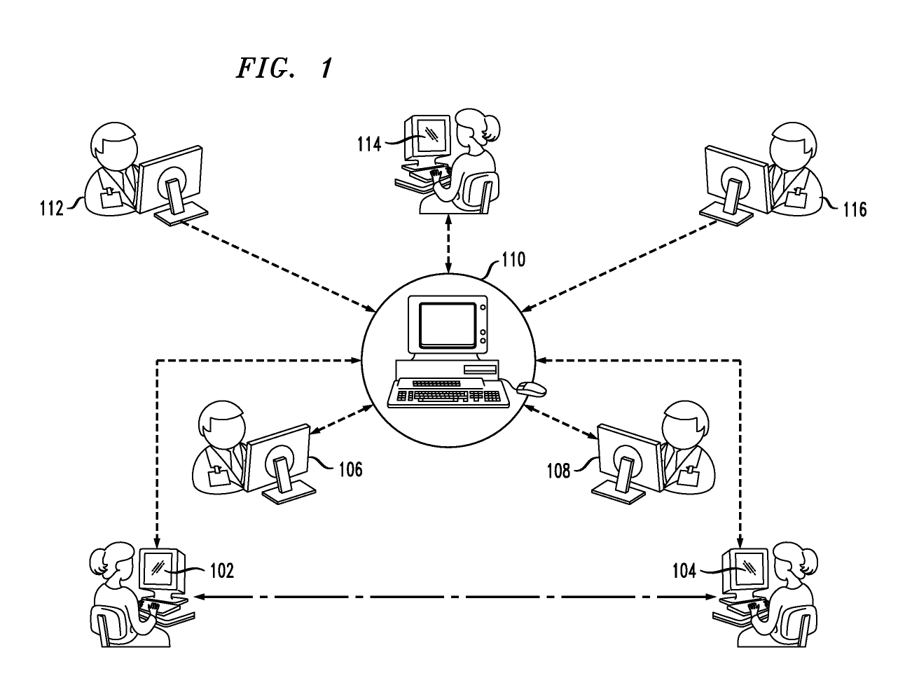

Attention should now be paid to FIG. 1 through FIG. 4.

FIG. 1 is a diagram illustrating an example network of analysts connected through a computational system, according to an embodiment of the present invention. By way of illustration, FIG. 1 depicts two computer users 102 and 104 (for example, a supervisee and a supervisor) connected through a computer network 110 into a computer system. FIG. 1 additionally depicts other analysts, 106, 108, 112, 114 and 116, connected through the computer network 110.

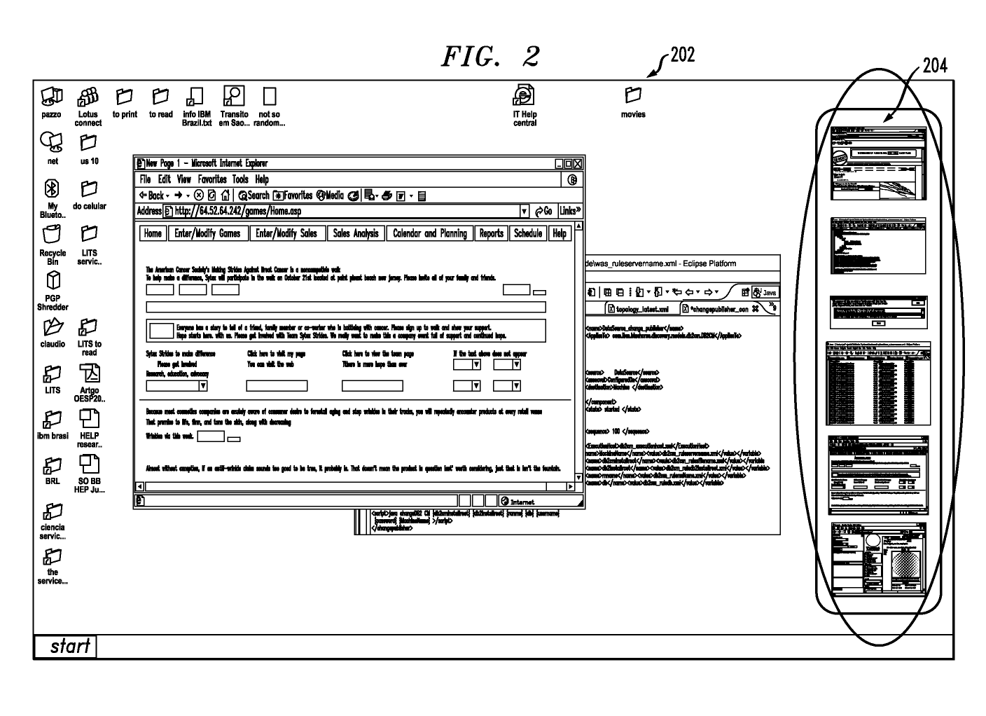

FIG. 2 is a diagram illustrating an example screen shot 202 of a supervisor tracking tasks done by others using activity summaries 204, according to an embodiment of the present invention.

FIG. 1 and FIG. 2 depict an example monitoring implementation of one embodiment of the invention. By way of example, in FIG. 1, two computer users (102 and 104), a supervisee and a supervisor, are connected through a computer network (110) into a computer system that implements the invention. An example sequence of interactions can include the following. A supervisee starts to perform a task. A supervisor sends a request to the system asking to assume the role of supervisor of the work being done by supervisee, to which the supervisee agrees.

The system, as depicted in FIG. 2, opens a small window (204) onto a supervisor screen, where a summary of the task being performed by the supervisee is presented. A log including the main steps (commands, user interface (UI) interactions, etc.) performed by supervisee is displayed as the task unfolds. In such a scenario, the supervisor uses an aspect of the invention to be aware of the task being executed by the supervisee. While the supervisor continues to carry out his or her own activities, s/he can keep the track of the supervisee's work as a secondary focus of attention, being able to identify necessities of (remote) interventions to help the supervisee with his or her job (give advices, improve quality/productivity, fix problems, etc.). In this context, a log can be any graphical representation of the activities performed, including a log of the commands, user interface (UI) interactions, written commands, and similar.

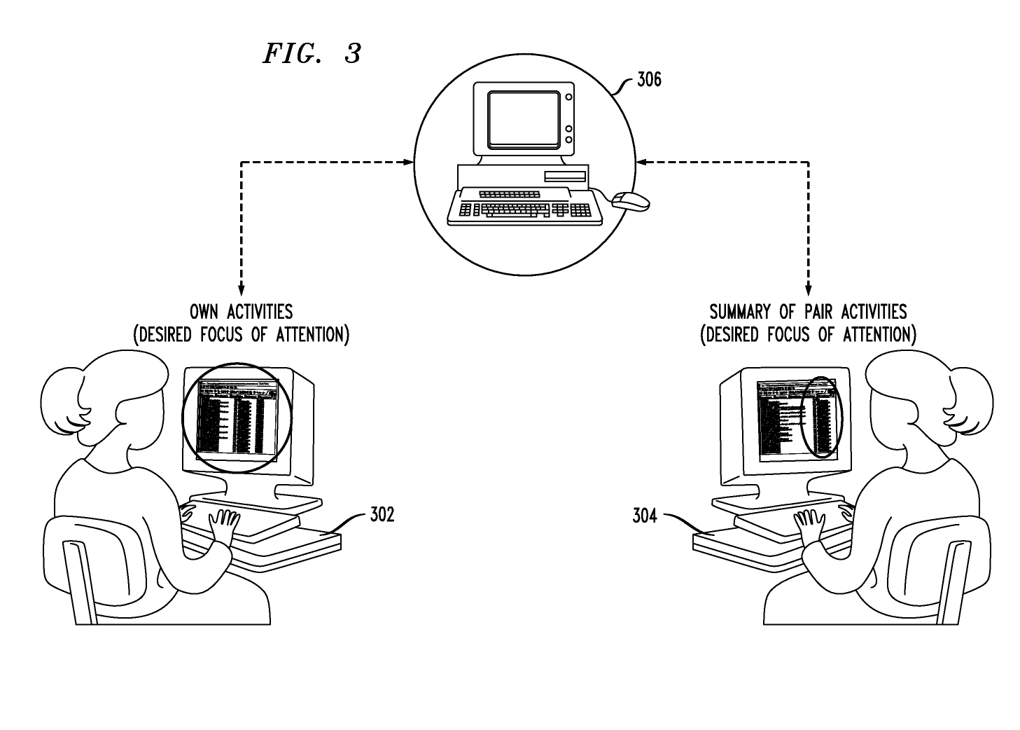

FIG. 3 is a diagram illustrating an example supervision scenario, according to an embodiment of the present invention. By way of illustration, FIG. 3 depicts two computer users 302 and 304, for example, a supervisee (302) and a supervisor (304), who are connected through a computer network 306 into a computer system that implements an aspect of the invention. An example sequence of interactions can include the following. A supervisee 302 starts to perform a task. A supervisor 304 sends a request to the system asking to assume the role of supervisor of the work being done by the supervisee, to which the supervisee 302 agrees.

Further, the system opens/pops up a small window into the supervisee's screen (similar to the window depicted in FIG. 2), where a summary of the task being performed by the mentor is shown. Also, a log composed of a summary of the main steps (commands, UI interactions, etc.) performed by the mentor is displayed on the apprentice's screen during the execution of the task.

In such a scenario, the supervisor uses the system to monitor the activities of the supervisee as they are being performed. While the supervisor is carrying out his or her own tasks, s/he is able to follow, with a smaller cognitive load, the work being executed by the supervisee. However, by monitoring the summary of the activities of the supervisee, the supervisor may decide to communicate with the supervisee in case of mistakes, better ways of performing tasks, or other comments about the work being performed.

Another possible scenario of the invention is a situation of apprenticeship. FIG. 3 is also a depiction of such a scenario, where the apprentice 304 uses the system to learn how to perform the task executed by the mentor 302. While the apprentice is carrying out his or her own activities, s/he may follow, in the background, the work being executed by the mentor as a secondary (or perhaps primary, if desired) focus of attention. Accordingly, an aspect of the invention provides a real-time (and low cost) opportunity for the training of less experienced professionals without distracting or disturbing other professionals.

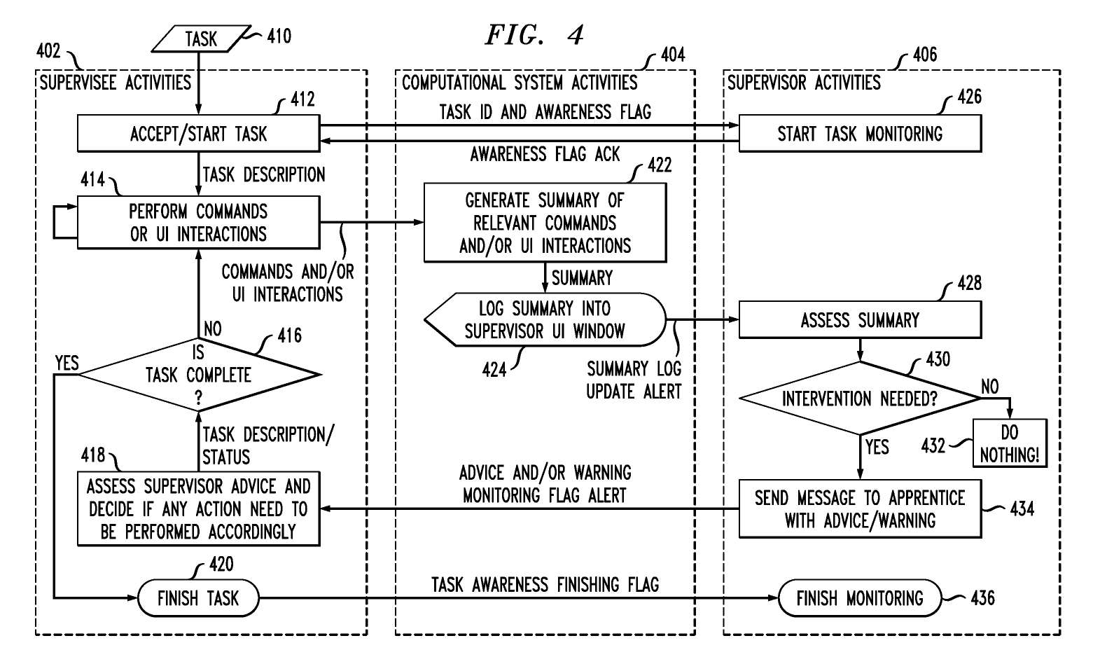

FIG. 4 is a diagram illustrating an example sequence of a supervising cycle based on task awareness and summarization, according to an embodiment of the present invention. By way of illustration, FIG. 4 depicts a supervisee module 402 that carries out steps 412 through 420, a computational system module 404 that carries out steps 422 and 424, and a supervisor module 406 that carries out steps 426 through 436.

Accordingly, step 412 includes accepting a task 410. Step 414 includes performing commands or UI interactions based on the task description. In step 416, a determination is made as to whether the task is complete. This determination is aided via step 418, wherein supervisor advice is assessed and a decision is made as to whether any action needs to be performed in accordance therewith. As such, if the task is deemed to not be complete, the sequence returns to step 414, while if the task is deemed complete, the task is finished at step 420.

Step 422 includes generating a summary of relevant commands and/or UI interactions upon receiving input of same from the supervisee module 402 (such as those performed in step 414). Step 424 includes presenting the generated summary into a supervisor UI window of the supervisor module 406.

Step 426 includes starting a task monitoring, which can include receiving a task identifier (ID) and an awareness flag from the supervisee module 402, as well as providing an awareness flag acknowledgement to the supervisee module. Step 428 includes assessing the summary generated and output by the computational system module 404. Further, in step 430, a determination is made as to whether an intervention is needed. If no, then step 432 includes taking no related action. If an intervention is needed, however, step 434 includes sending a message to the supervisee module 402 with advice and or a warning, or the supervisor using other means of communication to contact the supervisee. Additionally, in connection with the supervisee module completing the task in step 420, step 436 includes finishing monitoring.

In one or more embodiments of the invention, the implementation of the techniques described herein can be based on standard technologies (communication protocols, graphical development tools/languages, etc.) available to develop client-server applications over infrastructure of ordinary networks.

As detailed herein, summaries and logs of activities can be represented either as text or graphics, or both. In one embodiment of the invention, another way to present the information about a supervisee's tasks is to adopt a WYSIWIS (What You See Is What I See) user interface orientation in which the view presented to the supervisor is the exact same view of the supervisee, including its content, status, etc. Additionally, as detailed herein, such an embodiment of the invention includes using summaries instead of full images.

The monitoring of another's tasks can be associated with the concept of awareness. Awareness among group members can be achieved through various communication channels, such as video, audio, graphical user interfaces, gestures, etc. An aspect of the invention does not focus on tasks that are proximate. The supervisor and the supervisees may be performing completely unrelated tasks, and, even in this context, the techniques described herein will provide computer users with information about other users. In addition, an aspect of the invention adopts summarization approaches to simplify the amount and type of information being provided to other users. Further, one embodiment of the invention enables supervisees and supervisors to clearly establish when monitoring takes place, for example by turning off summarization features (either manually or automatically).

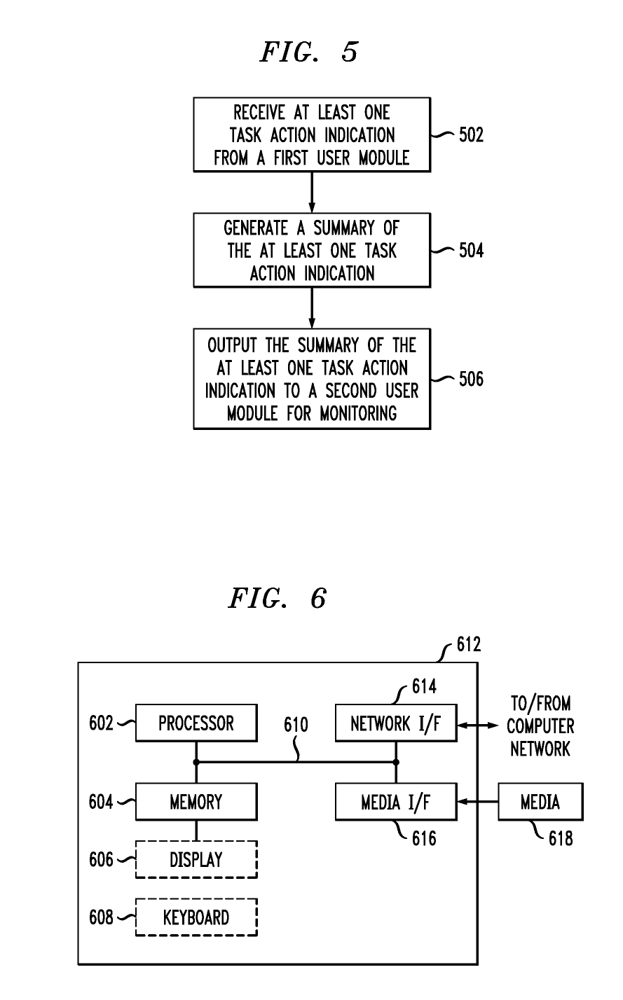

FIG. 5 is a flow diagram illustrating techniques for task monitoring, according to an embodiment of the present invention. Step 502 includes receiving at least one task action indication from a first user module. This step can be carried out, for example, using a computational system module. A task action indication can include, for example, a user command and/or a user interface interaction.

Step 504 includes generating a summary of the at least one task action indication. This step can be carried out, for example, using a computational system module. The summary includes at least one of text and graphics, and can also be represented using thumbnails in the second user module. Generating a summary of the task action indication(s) includes automatically processing a log or a similar type of record of the first user module activities on at least one of a computer, video and audio feed.

Step 506 includes outputting the summary of the at least one task action indication to a second user module for monitoring. This step can be carried out, for example, using a computational system module. Outputting the summary to a second user module includes presenting the generated summary into a user interface window of the second user module. Also, outputting the summary to a second user module can further includes outputting a log update alert to the second user module. Further, in one aspect of the invention outputting the summary to a second user module includes implementing a user interface orientation in which a view presented to the second user module is a reduced or identical view of the first user module. Additionally, as described herein, outputting the summary of the at least one task action indication to a second user module for monitoring is carried out in a manner to cause minimal disruption to the second user.

The techniques depicted in FIG. 5 additionally include facilitating sending a message from the second user module to the first user module in response to the generated summary of the at least one task action indication. Additionally, one embodiment of the invention includes enabling a user to establish when task monitoring takes place.

As detailed herein, one or more embodiments of the invention can be implemented in a scenario wherein the first user module is a supervisee module and the second user module is a supervisor module. Also, one or more embodiments of the invention can be implemented in a scenario wherein the first user module is a mentor module and the second user module is an apprentice module.

The techniques depicted in FIG. 5 can also, as described herein, include providing a system, wherein the system includes distinct software modules, each of the distinct software modules being embodied on a tangible computer-readable recordable storage medium. All the modules (or any subset thereof) can be on the same medium, or each can be on a different medium, for example. The modules can include any or all of the components shown in the figures. In an aspect of the invention, the modules include a supervisee module, a computational system module, and a supervisor module that can run, for example on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 5 can be implemented via a computer program product that can include computer useable program code that is stored in a computer readable storage medium in a data processing system, and wherein the computer useable program code was downloaded over a network from a remote data processing system. Also, in an aspect of the invention, the computer program product can include computer useable program code that is stored in a computer readable storage medium in a server data processing system, and wherein the computer useable program code are downloaded over a network to a remote data processing system for use in a computer readable storage medium with the remote system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in a computer readable medium having computer readable program code embodied thereon.

An aspect of the invention or elements thereof can be implemented in the form of an apparatus including a memory and at least one processor that is coupled to the memory and operative to perform exemplary method steps.

Additionally, an aspect of the present invention can make use of software running on a general purpose computer or workstation. With reference to FIG. 6, such an implementation might employ, for example, a processor 602, a memory 604, and an input/output interface formed, for example, by a display 606 and a keyboard 608. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 602, memory 604, and input/output interface such as display 606 and keyboard 608 can be interconnected, for example, via bus 610 as part of a data processing unit 612. Suitable interconnections, for example via bus 610, can also be provided to a network interface 614, such as a network card, which can be provided to interface with a computer network, and to a media interface 616, such as a diskette or CD-ROM drive, which can be provided to interface with media 618.

Accordingly, computer software including instructions or code for performing the methodologies of the invention, as described herein, may be stored in an associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 602 coupled directly or indirectly to memory elements 604 through a system bus 610. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 608, displays 606, pointing devices, and the like) can be coupled to the system either directly (such as via bus 610) or through intervening I/O controllers (omitted for clarity).

Network adapters such as network interface 614 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 612 as shown in FIG. 6) running a server program. It will be understood that such a physical server may or may not include a display and keyboard.

As noted, aspects of the present invention may take the form of a computer program product embodied in a computer readable medium having computer readable program code embodied thereon. Also, any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using an appropriate medium, including but not limited to wireless, wireline, optical fiber cable, RF, etc., or any suitable combination of the foregoing.

Computer program code for carrying out operations for aspects of the present invention may be written in any combination of at least one programming language, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. Accordingly, an aspect of the invention includes an article of manufacture tangibly embodying computer readable instructions which, when implemented, cause a computer to carry out a plurality of method steps as described herein.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, component, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 602. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, an appropriately programmed general purpose digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

At least one aspect of the present invention may provide a beneficial effect such as, for example, using summarization techniques to aid in monitoring or learning activities.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for task monitoring, wherein the method comprises:
receiving at least one task action indication from a first user module;
generating a summary of the at least one task action indication; and
outputting the summary of the at least one task action indication to a second user module for monitoring;
wherein at least one of the steps is carried out by a computer device.

2. The method of claim 1, further comprising facilitating sending a message from the second user module to the first user module in response to the generated summary of the at least one task action indication.

3. The method of claim 1, wherein a task action indication comprises a user command.

4. The method of claim 1, wherein a task action indication comprises a user interface interaction.

5. The method of claim 1, wherein outputting the summary of the at least one task action indication to a second user module comprises presenting the generated summary into a user interface window of the second user module.

6. The method of claim 1, wherein outputting the summary of the at least one task action indication to a second user module further comprises outputting a log update alert to the second user module.

7. The method of claim 1, wherein the summary includes at least one of text and graphics.

8. The method of claim 1, wherein the summary is represented using at least one thumbnail in the second user module.

9. The method of claim 1, wherein outputting the summary of the at least one task action indication to a second user module comprises implementing a user interface orientation in which a view presented to the second user module is a reduced or identical view of the first user module.

10. The method of claim 1, wherein the first user module comprises a supervisee module and the second user module comprises a supervisor module.

11. The method of claim 1, wherein the first user module comprises a mentor module and the second user module comprises an apprentice module.

12. The method of claim 1, wherein generating a summary of the at least one task action indication comprises automatically processing a log or a similar type of record of the first user module activities on at least one of a computer, video and audio feed.

13. The method of claim 1, further comprising enabling a user to establish when task monitoring takes place.

14. The method of claim 1, further comprising:
providing a system, wherein the system comprises at least one distinct software module, each distinct software module being embodied on a tangible computer-readable recordable storage medium, and wherein the at least one distinct software module comprises a supervisee module, a computational system module, and a supervisor module executing on a hardware processor.

15. An article of manufacture comprising a computer readable storage medium having computer readable instructions tangibly embodied thereon which, when implemented, cause a computer to carry out a plurality of method steps comprising:
receiving at least one task action indication from a first user module;
generating a summary of the at least one task action indication; and
outputting the summary of the at least one task action indication to a second user module for monitoring.

16. The article of manufacture of claim 15, wherein the computer readable instructions which, when implemented, further cause a computer to carry out a method step comprising:
facilitating sending a message from the second user module to the first user module in response to the generated summary of the at least one task action indication.

17. The article of manufacture of claim 15, wherein outputting the summary of the at least one task action indication to a second user module comprises presenting the generated summary into a user interface window of the second user module.

18. The article of manufacture of claim 15, wherein the summary includes at least one of text and graphics.

19. The article of manufacture of claim 15, wherein generating a summary of the at least one task action indication comprises automatically processing a log or a similar type of record of the first user module activities on at least one of a computer, video and audio feed.

20. A system for task monitoring, comprising:
at least one distinct software module, each distinct software module being embodied on a tangible computer-readable medium;
a memory; and
at least one processor coupled to the memory and operative for:
receiving at least one task action indication from a first user module;
generating a summary of the at least one task action indication; and
outputting the summary of the at least one task action indication to a second user module for monitoring.

21. The system of claim 20, wherein the at least one processor coupled to the memory is further operative for:
facilitating sending a message from the second user module to the first user module in response to the generated summary of the at least one task action indication.

22. The system of claim 20, wherein the at least one processor coupled to the memory operative for outputting the summary of the at least one task action indication to a second user module is further operative for presenting the generated summary into a user interface window of the second user module.

23. The system of claim 20, wherein the summary includes at least one of text and graphics.

24. The system of claim 20, wherein the at least one processor coupled to the memory operative for generating a summary of the at least one task action indication is further operative for automatically processing a log or a similar type of record of the first user module activities on at least one of a computer, video and audio feed.
